(19) United States
(12) Patent Application Publication
(10) Pub. No.: US 2010/0323946 A1
(43) Pub. Date: Dec. 23, 2010

(54) Liquid Cleaning Compositions and Methods of Use and Manaufacture

(75) Inventors: Thomas Connors, Piscataway, NJ (US); Gary Jakubicki, Robbinsville, NJ (US); Gregory Szewczyk, Flemington, NJ (US); Petra Archibald, Hillside, NJ (US); Philip Anthony Gorlin, Flemington, NJ (US)

Correspondence Address: COLGATE-PALMOLIVE COMPANY, 909 RIVER ROAD, PISCATAWAY, NJ, 08855, US

(73) Assignee: COLGATE-PALMOLIVE COMPANY, New York, NY (US)

(21) Appl. No.: 12/521,663

(22) PCT Filed: May 19, 2009
(86) PCT No.: PCT/US09/44427

§ 371 Date: Jun. 29, 2009

Related U.S. Application Data
(60) Provisional application No. 61/055,484, filed on May 23, 2008.

(51) Int. Cl. C11D 1/83

(52) U.S. Cl. 510/429

(57) ABSTRACT

This invention encompasses a light duty liquid detergent composition that includes a C₁₄-C₁₅ alcohol and alcohol ethoxylate sulfate surfactant blend as an efficient and effective foaming agent. The surfactant-based product may be a hand dishwashing liquid, a liquid skin cleanser or any type of cleaning or cleansing product based on surfactants. Specifically, the invention relates to a light duty liquid detergent composition with desirable cleansing properties and foaming capability including an anionic sulfonate surfactant, an amine oxide, a C₁₄-C₁₅ alcohol, and a C₁₄-C₁₅ alcohol ethoxylate sulfate.

### CROSS REFERENCE TO RELATED APPLICATIONS

This application claims priority to U.S. Application Ser. No. 61/055,484, filed on 23 May 2008, which is incorporated herein by reference.

### FIELD OF THE INVENTION

This invention relates to liquid cleaning compositions that include a C₁₄-C₁₅ alcohol and alcohol ethoxylate sulfate surfactant blend as an efficient and effective foaming agent. In certain embodiments, the invention relates to a light duty liquid cleaning composition. The surfactant-based products may be hand dishwashing liquids, liquid skin cleansers or any type of cleaning or cleansing product based on surfactants. Specifically, the invention relates to light duty liquid detergent compositions with desirable cleansing properties and foaming capability including an anionic sulfonate surfactant, an amine oxide, a C₁₄-C₁₅ alcohol, and a C₁₄-C₁₅ alcohol ethoxylate sulfate, as well as methods of making and using such compositions.

### BACKGROUND OF THE INVENTION

In formulating detergent compositions for cleaning surfaces, such as light-duty liquid or gel dishwashing detergent compositions, laundry bars, personal cleansing compositions (such as shampoos and body washes) and the like, the problem of non-foaming is a concern.

Nonionic surfactants are in general chemically inert and stable toward pH change and are therefore well suited for mixing and formulation with other materials. The superior performance of nonionic surfactants on the removal of oily soil is well recognized. Nonionic surfactants are also known to be mild to human skin. However, as a class, nonionic surfactants are known to be low or moderate foaming agents. Consequently, for detergents which require copious and stable foam, the use of nonionic surfactants is limited. There have been substantial interest and efforts to develop a high foaming detergent with nonionic surfactants as the major ingredient. Little has been achieved.

Light duty liquid detergent compositions containing nonionic surfactants in combination with anionic and/or betaine surfactants, where the nonionic detergent is not the major active surfactant and an anionic based shampoo contains a minor amount of a fatty acid alkanolamide are known to be poor in forming foam. Betaine-based shampoos containing minor amounts of nonionic surfactants result in low foaming properties which renders its use in shampoo compositions to be non-preferred. Moreover, shampoos containing a betaine surfactant as the major ingredient and minor amounts of a nonionic surfactant and of a fatty acid mono- or di-ethanolamide also exhibit problems with foaming.

Consequently, there remains a need for a detergent composition, which can have the best possible cleaning and foaming properties, while being suitable for use in home care and personal care products.

### BRIEF SUMMARY OF THE INVENTION

It has now been found that a light duty liquid cleaning composition as an effective foaming agent can be formulated, which includes at least one C₁₄-C₁₅ alcohol and alcohol ethoxylate sulfate blend, at least one amine oxide surfactant, and at least one anionic surfactant.

Accordingly, in certain embodiments, the present invention provides a cleaning composition designed for home care and personal care cleaning and providing effective foaming. In certain embodiments, the cleaning composition includes at least one C₁₄-C₁₅ alcohol sulfate, at least one C₁₄-C₁₅ alcohol ethoxylate sulfate. In other embodiments, the cleaning composition includes at least one C₁₄-C₁₅ alcohol sulfate, at least one C₁₄-C₁₅ alcohol ethoxylate sulfate, at least one amine oxide surfactant, and at least one anionic sulfonate surfactant, which has both good cleaning properties and effective foaming capacity on hard surfaces. In particular, it has been found that a C₁₄-C₁₅ alcohol and alcohol ethoxylate sulfate blend demonstrates improved foaming ability over known light duty liquid detergents.

In another embodiment, the present invention is directed to a light duty liquid cleaning composition that comprises about 0.1 wt. % to about 5 wt. % of an anionic sulfonate surfactant, about 0.1 wt. % to about 5 wt. % of an amine oxide, about 2 wt. % to about 10 wt. % of a C₁₄-C₁₅ alcohol sulfate, about 2 wt. % to about 10 wt. % of a C₁₄-C₁₅ alcohol ethoxylate sulfate, and water.

In another embodiment, the present invention is directed to a method of making a light duty liquid detergent useful for home care or personal care, wherein the light duty liquid detergent has effective foaming capability, the method comprising combining at least one C₁₄-C₁₅ alcohol, at least one C₁₄-C₁₅ alcohol ethoxylate sulfate, at least one amine oxide surfactant, and at least one anionic surfactant, and water.

In another embodiment, the present invention is directed to a method of making a light duty liquid detergent useful for home care or personal care, wherein the light duty liquid detergent has effective foaming capability, the method comprising combining about 0.1 wt. to about 5 wt. % of an anionic sulfonate surfactant, about 0.1 wt. % to about 5 wt. % of an amine oxide, about 2 wt. % to about 10 wt. % of a C₁₄-C₁₅ alcohol sulfate, and about 2 wt. % to about 10 wt. % of a C₁₄-C₁₅ alcohol ethoxylate sulfate, and water.

To achieve the foregoing and other embodiments and in accordance with the purpose of the present invention, as embodied and broadly described herein the light duty liquid detergent of this invention includes at least one anionic sulfonate surfactant, at least one aliphatic ethoxylated surfactant, at least one alcohol, at least one amine oxide, and water.

### DETAILED DESCRIPTION OF THE INVENTION

As used throughout, ranges are used as a shorthand for describing each and every value that is within the range. Any value within the range can be selected as the terminus of the range. In addition, all references cited herein are hereby incorporated by reference in their entireties. In the event of a conflict in a definition in the present disclosure and that of a cited reference, the present disclosure controls.

The present invention relates to a light duty liquid cleaning composition, methods of manufacture and methods of use, which includes:

(i) at least one C₁₄-C₁₅ alcohol sulfate; and

(ii) at least one C₁₄-C₁₅ alcohol ethoxylate sulfate.

The invention also relates to a light duty liquid cleaning composition, methods of manufacture and methods of use, which includes:

(i) at least one anionic sulfonate surfactant;

(ii) at least one amine oxide;

(iii) at least one C₁₄-C₁₅ alcohol sulfate; and

(iv) at least one C₁₄-C₁₅ alcohol ethoxylate sulfate.

In another embodiment, the present invention relates to a light duty liquid cleaning, composition, methods of manufacture and methods of use, which includes approximately by weight:

(i) about 2 wt. % to about 10 wt. % of a C₁₄-C₁₅ alcohol sulfate; and

(ii) about 2 wt. % to about 10 wt. % of a C₁₄-C₁₅ alcohol ethoxylate sulfate.

In still another embodiment, the present invention relates to a light duty liquid cleaning composition, methods of manufacture and methods of use, which includes approximately by weight:

(i) about 0.1 wt. % to about 5 wt. % of an anionic sulfonate surfactant;

(ii) about 0.1 wt. % to about 5 wt. % of an amine oxide;

(iii) about 2 wt. % to about 10 wt. % of a C₁₄-C₁₅ alcohol sulfate; and

(iv) about 2 wt. % to about 10 wt. % of a C₁₄-C₁₅ alcohol ethoxylate sulfate.

### Anionic Surfactants

The anionic sulfonate surfactants that may be used in the all-purpose cleaners of this invention include water soluble anionic sulfonate surfactants and include, but are not limited to, sodium, potassium, ammonium, magnesium and ethanolammonium salts of linear C₈-C₁₆ alkyl benzene sulfonates; C₁₀-C₂₀ paraffin sulfonates, alpha olefin sulfonates containing about 10-24 carbon atoms and C₈-C₁₈ alkyl sulfates and mixtures thereof.

In one embodiment, examples of suitable sulfonated anionic surfactants include, but are not limited to, alkyl mononuclear aromatic sulfonates, such as the higher alkylbenzene sulfonates containing in one embodiment 9 to 18 carbon atoms, in another embodiment 11 to 16 carbon atoms, and in another embodiment 14 or 15 carbon atoms, the higher alkyl group in a straight or branched chain, or C₈₋₁₅ alkyl toluene sulfonates and C₈-C₁₅ alkyl phenol sulfonates. In another embodiment, the alkylbenzene sulfonate is a linear alkylbenzene sulfonate having a higher content of 3-phenyl (or higher) isomers and a correspondingly lower content (well below 50%) of 2-phenyl (or lower) isomers, such as those sulfonates wherein the benzene ring is attached mostly at the 3 or higher (for example 4, 5, 6 or 7) position of the alkyl group and the content of the isomers in which the benzene ring is attached in the 2 or 1 position is correspondingly low. Illustrative materials are set forth in U.S. Pat. No. 3,320,174, especially those in which the alkyls are of 14 or 15 carbon atoms.

In another embodiment, examples of suitable sulfonated anionic surfactants include, but are not limited to, those surface-active or detergent compounds, which contain an organic hydrophobic group containing generally 8 to 26 carbon atoms or 10 to 18 carbon atoms in their molecular structure. Usually, the hydrophobic group will include a C₈-C₂₂, alkyl, alkyl or acyl group. Such surfactants are employed in the form of water-soluble salts and the salt-forming cation usually is selected from the group consisting of sodium, potassium, ammonium, magnesium and mono-, di- or tri-C₂-C₃ alkanolammonium. In an illustrative embodiment the cations are sodium, magnesium or ammonium cations.

Other suitable anionic surfactants encompassed within the scope of the invention include the olefin sulfonates, including long-chain alkene sulfonates, long-chain hydroxyalkane sulfonates or mixtures of alkene sulfonates and hydroxyalkane sulfonates. These olefin sulfonate detergents may be prepared in a known manner by the reaction of sulfur trioxide (SO₃) with long-chain olefins containing 8 to 25, or 12 to 21 carbon atoms and having the formula RCH═CHR₁ where R is a higher alkyl group of 6 to 23 carbons and R₁ is an alkyl group of 1 to 17 carbons or hydrogen to form a mixture of sulfones and alkene sulfonic acids which is then treated to convert the sulfones to sulfonates. In other embodiments olefin sulfonates contain from 14 to 16 carbon atoms in the R alkyl group and are obtained by sulfonating an alpha-olefin.

Other examples of suitable anionic sulfonate surfactants encompassed within the scope of the invention include the paraffin sulfonates containing about 10 to 20, or about 13 to 17 carbon atoms. Primary paraffin sulfonates are made by reacting long-chain alpha olefins and bisulfites and paraffin sulfonates having the sulfonate group distributed along the paraffin chain are shown in U.S. Pat. Nos. 2,503,280; 2,507,088; 3,260,744; 3,372,188; and German Patent 735,096.

In one embodiment, the anionic surfactant is present in an amount of about 0.01 wt. % to 10 wt. %. In another embodiment, the anionic surfactant is present in an amount of about 0.1 wt. % to 5 wt. %. In another embodiment, the anionic surfactant is present in an amount of about 0.01 wt. % to 3 wt. %. In another embodiment, the anionic surfactant is present in an amount of about 1 wt. % to 2 wt. %. In another embodiment, the anionic surfactant is present in an amount of about 1.5 wt. %.

### Amine Oxides

The compositions of the invention also include at least one amine oxide. The amine oxides are semi-polar nonionic surfactants, which include compounds and mixtures of compounds having the formula of FIG. 1:

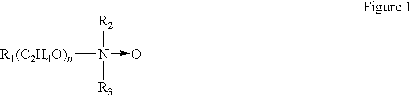

wherein R₁ is an alkyl, 2-hydroxyalkyl, 3-hydroxyalkyl, or 3-alkoxy-2-hydroxypropyl radical in which the alkyl and alkoxy, respectively, contain from 8 to 18 carbon atoms, R₂ and R₃ are each methyl, ethyl, propyl, isopropyl, 2-hydroxyethyl, 2-hydroxypropyl, or 3-hydroxypropyl, and n is from 0 to 10.

Certain illustrative embodiments encompass amine oxides of the formula of FIG. 2:

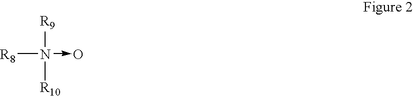

wherein R₈ is a C₁₂₋₁₆ alkyl group or amido radical:

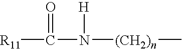

wherein R₁₁ is an alkyl group having about 9 to 19 carbon atoms and a is an integer 1 to 4 and R₉ and R₁₀ are methyl or ethyl. The above ethylene oxide condensates, amides, and amine oxides are more fully described in U.S. Pat. No. 4,316,824, which is hereby incorporated herein by reference. In other illustrative embodiments, the amine oxides are chosen from lauryol amine oxide, cocoamido propyl amine oxide and cocoamido propyl dimethyl amine oxide.

In various embodiments, the concentration of the amine oxide in the instant compositions is about 0.01 wt. % to about 30 wt. %, about 0.1 wt. % to about 10 wt. %, about 0.1 wt. % to about 5 wt. %, about 1 wt. % to about 3 wt. %, about 1 wt. % to 2 wt. % or about 1.1 wt. %.

### C₁₄-C₁₅ Alcohol Sulfates

It has been found that the use of C₁₄-C₁₅ alcohol ether sulfates is particularly effective in their foaming ability. In certain embodiments, the alcohol ether sulfate is an alkylbenzene sulfonic acid. In another illustrative embodiment, the alcohol ether sulfate is sodium myristyl sulfate, prepared by sulfation of myristyl alcohol and neutralization with sodium carbonate, which has an amphiphilic properties due to C14 chain (lipophilic) attached to a sulfate group (hydrophilic). This bifunctionality in one molecule provides the basic properties useful in cleaners and detergents. Ammonium lauryl sulfate (ALS) is a structurally related compound, replacing ammonium group for sodium. They have the same applications. But they cause skin and eye irritation, and are therefore not useful in products that are on the skin for a long time. The ethoxylated SLS and ALS are less irritant on the skin; sodium laureth sulfate (sodium lauryl ether sulfate, SLES) and ammonium laureth sulfate (ammonium lauryl ether sulfate, ALES) which are prepared by addition of ethylene oxide. SLES and ALES are used as a foaming and viscosity builder in shampoos and personal care products (such as bubble bath, shaving cream, ointment, and tooth pastes sometimes) particularly of low pH products. One more common feature of them appears to be the compatibility with other surfactants.

### Alcohol Oxylate Ether Sulfate Surfactants

In certain embodiments, the compositions of the present invention also include at least one water soluble aliphatic ethoxylated surfactant. The aliphatic ethoxylated surfactants utilized in this invention are commercially known and include the primary aliphatic alcohol ethoxylates and secondary aliphatic alcohol ethoxylates. The length of the polyethenoxy chain can be adjusted to achieve the desired balance between the hydrophobic and hydrophilic elements.

Generally, the alcohol ethoxylate surfactants can be purchased or generated using methods known to those of ordinary skill in the art including a KOH ethoxylation catalyst. It has surprisingly been found that C₁₄-C₁₅ alcohol ethoxylate sulfates are surprisingly efficient and effective in their foaming capabilities. In one illustrative embodiment, the C₁₄-C₁₅ alcohol ethoxylate surfactant is Safol® 45E3 Sodium Ether Sulfate. A synthesis of alcohol ethoxylates is also described in Grant-Huyser et al., J. Surfactant Chemistry, Vol. 7, No. 4 (October 2004) 397-407, which is incorporated by reference in its entirety.

The ethoxylated alkyl ether sulfate may be made by, for example, sulfating the condensation product of ethylene oxide and C₈₋₁₆ alkanol, and neutralizing the resultant product. The ethoxylated alkyl ether sulfates differ from one another in the number of carbon atoms in the alcohols and in the number of moles of ethylene oxide reacted with one mole of such alcohol. In certain illustrative embodiments, ethoxylated alkyl ether polyethenoxy sulfates contain 14 to 15 carbon atoms in the alcohols and in the alkyl groups thereof, e.g., sodium myristyl (3 EO) sulfate.

In other embodiments, the alcohol ethoxylate sulfate surfactant may include the condensation products of a higher alcohol (e.g., an alkanol containing about 8 to 16 carbon atoms in a straight or branched chain configuration) condensed with about 4 to 20 moles of ethylene oxide, for example, lauryl or myristyl alcohol condensed with about 16 moles of ethylene oxide (EO), tridecanol condensed with about 6 to 15 moles of EO, myristyl alcohol condensed with about 10 moles of EO per mole of myristyl alcohol, the condensation product of EO with a cut of coconut fatty alcohol containing a mixture of fatty alcohols with alkyl chains having about 10 to about 14 carbon atoms in length and wherein the condensate contains either about 6 moles of EO per mole of total alcohol or about 9 moles of EO per mole of alcohol and tallow alcohol ethoxylates containing 6 EO to 11 EO per mole of alcohol.

In other embodiments, illustrative examples of alcohol ethoxylates, which can be utilized in the invention include, but are not limited to, Neodol® ethoxylates (Shell Co.), which are higher aliphatic, primary alcohol containing about 8 to 16 carbon atoms, such as C₉-C₁₁ alkanol condensed with 4 to 10 moles of ethylene oxide (Neodol® 91-8 or Neodol 91-5), C₁₂₋₁₃ alkanol condensed with 6.5 moles ethylene oxide (Neodol® 23-6.5). C₁₂₋₁₅ alkanol condensed with 12 moles ethylene oxide (Neodol® 25-12), C₁₄₋₁₅ alkanol condensed with 13 moles ethylene oxide (Neodol® 45-13), and the like. Such ethoxamers have an HLB (hydrophobic lipophilic balance) value of about 8 to 15 and give good 0/W emulsification, whereas ethoxamers with HLB values below 7 contain less than 4 ethyleneoxide groups and tend to be poor emulsifiers and poor detergents.

Additional water soluble alcohol ethylene oxide condensates within the scope of the invention include, but are not limited to, the condensation products of a secondary aliphatic alcohol containing 8 to 18 carbon atoms in a straight or branched chain configuration condensed with 5 to 30 moles of ethylene oxide. Examples of commercially available nonionic detergents of the foregoing type are C₁₁-C₁₅ secondary alkanol condensed with either 9 EO (Tergitol® 15-S-9) or 12 EO (Tergitol® 15-S-12) marketed by Union Carbide.

The water soluble ethoxylated/propoxylated nonionic surfactants, which may be utilized in this invention also include aliphatic ethoxylated/propoxylated nonionic surfactants, which are depicted by the formula of FIG. 3 of FIG. 4:

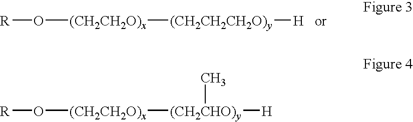

wherein R is a branched chain alkyl group having about 10 to about 16 carbon atoms, for example, an isotridecyl group and x and y are independently numbered from 1 to 20. Another embodiment encompasses ethoxylated/propoxylated nonionic surfactant is Plurafac® 300 manufactured by BASF.

In various embodiments, the aliphatic ethoxylated nonionic surfactant is present in an amount of about 0.01 wt. % to about 10 wt. %, about 0.1 wt. % to 5 wt. %, about 0.01 wt. % to 3 wt. %, about 1 wt. % to 2 wt. % or about 1 wt. %.

In certain embodiments, the compositions of the present invention may also include one or more alkyl ethoxylated ether sulfates. Additionally, a metal salt of a C₈-C₁₈ alkyl ethoxylated ether sulfate is another surfactant that may be utilized in the instant composition at a concentration of, in various embodiments, about 2 to about 15% by weight or about 4 to 14% by weight. The ethoxylated alkyl ether sulfate (AEOS.xEO) may be depicted by the formula of FIG. 5:

R—(OCH(CH₃)CH₂)xOSO₃M FIG. 5

where x is about 1 to about 22 or about 1 to about 10; R is an alkyl group having about 8 to about 18 carbon atoms or about 12 to about 15 carbon atoms.

In certain embodiments, R is C₁₂-C₁₄, C₁₂-C₁₃ and C₁₄₋₁₅ and M is an alkali metal cation such as lithium, potassium and sodium and an alkali earth metal cation such as magnesium.

Other examples of anionic ethoxylated sulfate are the C₈₋₁₈ ethoxylated alkyl ether sulfate salts having the formula of FIG. 6:

R′(OCH₂CH₂)nOSO₃M FIG. 6

where R′ is an alkyl group with 8 to 18 carbon atoms, n is 1 to 22 or 1 to 5; and M is a sodium cation.

The ethoxylated alkyl ether sulfates may be made by, for example, sulfating the condensation product of ethylene oxide and C₈₋₁₈ alkanol, and neutralizing the resultant product. The ethoxylated alkyl ether sulfates may differ from one another in the number of carbon atoms in the alcohols and in the number of moles of ethylene oxide reacted with one mole of such alcohol. In certain embodiments, ethoxylated alkyl ether sulfates contain 10 to 16 carbon atoms in the alcohols and in the alkyl groups thereof.

Also suitable for use in the present embodiments are ethoxylated C₈₋₁₈ alkylphenyl ether sulfates containing about 2 to about 6 moles of ethylene oxide in the molecule. These detergents can be prepared by reacting an alkyl phenol with about 2 to about 6 moles of ethylene oxide and sulfating and neutralizing the resultant ethoxylated alkylphenol by about 5 to 20%, in various embodiments about 16% or about 13%. The resultant composition, which will also contain free hydroxyl ions, will have a pH of, kin various embodiments, at least about 12, at least about 13, about 12 to 14, about 13 to 14, about 13.5 or about 14.

The final ingredient in the inventive cleaning compositions is water. The proportion of water in the compositions generally is in the range of about 35% to 90% or about 50% to 85% by weight of the cleaning composition.

The stabilized compositions may optionally contain one or more additional surfactants such as anionic, amphoteric, zwitterionic, nonionic, cationic, or combinations thereof or other ingredients including solubilizers.

### Optional Ingredients

Examples of optional components that may be useful for the present embodiments include, but are not limited to: nonionic surfactants, amphoteric and zwitterionic surfactants, anionic surfactants, cationic surfactants, hydrotropes, fluorescent whitening agents, photobleaches, fiber lubricants, reducing agents, enzymes, enzyme stabilizing agents, powder finishing agents, builders, bleaches, bleach catalysts, soil release agents, dye transfer inhibitors, buffers, colorants, fragrances, pro-fragrances, rheology modifiers, anti-ashing polymers, preservatives, soil repellents, water-resistance agents, suspending agents, aesthetic agents, structuring agents, sanitizers, solvents, fabric finishing agents, dye fixatives, fabric conditioning agents and deodorizers.

Optionally, a soluble preservative may be added to compositions of the present invention. In one embodiment, the preservative is a broad-spectrum preservative, which controls the growth of bacteria and fungi. Limited-spectrum preservatives, which are only effective on a single group of microorganisms may also be used, either in combination with a broad-spectrum material or in a “package” of limited-spectrum preservatives with additive activities. Depending on the circumstances of manufacturing and consumer use, it may also be desirable to use more than one broad-spectrum preservative to minimize the effects of any potential contamination.

Biocidal materials may be optionally added to the compositions of the present invention. As used herein, “biocidal materials” refer to substances that kill or destroy bacteria or fungi, and/or regulate or retard the growth of microorganisms. As used herein, biocidal materials may include, for example, antibacterial compositions, antiviral compositions and compositions such as such as biostatic preservatives.

The compositions of the present invention may optionally contain one or more solubilizing agents, in an amount of about 0.25 wt. % to about 10 wt. % or about 1 wt. % to about 8 wt. %. Useful solubilizing agents include, but are not limited to, C₁₋₅ mono, dihydroxy or polyhydroxy alkanols such as ethanol, isopropanol, alkylene glycols such as hexylene glycol, glycerol ethylene glycol, diethylene glycol and propylene glycol and mixtures thereof and alkali metal cumene or xylene sulfonates such as sodium cumene sulfonate and sodium xylene sulfonate. The solubilizing agents may be included in order to control low temperature cloud clear properties. Urea can be optionally employed in the instant composition as a supplemental solubilizing agent at a concentration of 0 to about 10 wt. %, or about 0.5 wt. % to about 8 wt. %.

The anionic surfactant may be any anionic surfactant known in the art of aqueous surfactant compositions. Suitable anionic surfactants include but are not limited to: alkyl sulfates, alkyl ether sulfates, alkaryl sulfonates, alkyl succinates, alkyl sulfosuccinates. N-alkoyl sarcosinates, alkyl phosphates, alkyl ether phosphates, alkyl ether carboxylates, alkylamino acids, alkyl peptides, alkoyl taurates, carboxylic acids, acyl and alkyl glutamates, alkyl isethionates, and alpha-olefin sulfonates, especially their sodium, potassium, magnesium, ammonium and mono-, di- and triethanolamine salts. The alkyl groups generally contain 8 to 18 carbon atoms and may be unsaturated. The alkyl ether sulfates, alkyl ether phosphates and alkyl ether carboxylates may contain 1 to 10 ethylene oxide or propylene oxide units per molecule, and in certain embodiments contain 1 to 3 ethylene oxide units per molecule.

Examples of suitable anionic surfactants include sodium and ammonium lauryl ether sulfate (with 1, 2, and 3 moles of ethylene oxide), sodium, ammonium, and triethanolamine lauryl sulfate, disodium laureth sulfosuccinate, sodium cocoyl isethionate, sodium C₁₂-C₁₄ olefin sulfonate, sodium laureth-6 carboxylate, sodium C₁₂-C₁₅ pareth sulfate, sodium methyl cocoyl taurate, sodium dodecylbenzene sulfonate, sodium cocoyl sarcosinate, triethanolamine monolauryl phosphate, and fatty acid soaps.

The nonionic surfactant can be any nonionic surfactant known in the art of aqueous surfactant compositions. Suitable nonionic surfactants include but are not limited to aliphatic (C₆-C₁₈) primary or secondary linear or branched chain acids, alcohols or phenols, alkyl ethoxylates, alkyl phenol alkoxylates (especially ethoxylates and mixed ethoxy/propoxy), block alkylene oxide condensate of alkyl phenols, alkylene oxide condensates of alkanols, ethylene oxide/propylene oxide block copolymers, semi-polar nonionics (e.g., amine oxides and phospine oxides), as well as alkyl amine oxides. Other suitable nonionics include mono or di alkyl alkanolamides and alkyl polysaccharides, sorbitan fatty acid esters, polyoxyethylene sorbitan fatty acid esters, polyoxyethylene sorbitol esters, polyoxyethylene acids, and polyoxyethylene alcohols. Examples of suitable nonionic surfactants include coco mono or diethanolamide, coco diglucoside, alkyl polyglucoside, cocamidopropyl and lauramine oxide, polysorbate 20, ethoxylated linear alcohols, cetearyl alcohol, lanolin alcohol, stearic acid, glyceryl stearate, PEG-100 stearate, and oleth 20.

Amphoteric and zwitterionic surfactants are those compounds which have the capacity of behaving either as an acid or a base. These surfactants can be any of the surfactants known or previously used in the art of aqueous surfactant compositions. Suitable materials include but are not limited to alkyl betaines, alkyl amidopropyl betaines, alkyl sulphobetaines, alkyl glycinates, alkyl carboxyglycinates, alkyl amphopropionates, alkyl amidopropyl hydroxysultaines, acyl taurates and acyl glutamates wherein the alkyl and acyl groups have from 8 to 18 carbon atoms. Examples include cocamidopropyl betaine, sodium cocoamphoacetate, cocamidopropyl hydroxysultaine, and sodium cocamphopropionate.

The cationic surfactants can be any cationic surfactant known in the art of aqueous surfactant compositions. Suitable cationic surfactants include but are not limited to alkyl amines, alkyl imidazolines, ethoxylated amines, quaternary compounds, and quaternized esters. In addition, alkyl amine oxides can behave as a cationic surfactant at a low pH. Examples include lauramine oxide, dicetyldimonium chloride, cetrimonium chloride.

Other surfactants that can be utilized in the present invention include those described in WO 99/21530, U.S. Pat. No. 3,929,678; U.S. Pat. No. 4,565,647; U.S. Pat. No. 5,720,964; and U.S. Pat. No. 5,858,948, as well as McCutcheon's Emulsifiers and Detergents (North American and International Editions, by Schwartz, Perry and Berch), all of which are hereby fully incorporated by reference.

While amounts of the additional optional surfactant can vary widely, in various embodiments, one or more optional surfactants are present in an amount of about 1% to about 80%, about 5% to about 65%, about 6% to about 30% or about 8% to 20% weight based upon the total weight of the composition.

The compositions of the present invention have a wide number of applications such as personal care applications, home care applications, industrial and institutional applications, pharmaceutical applications, textile applications and the like.

Examples of various personal care applications include products such as the following: shampoos, skin and body cleansers such as body washes, bath and shower gels; hand soaps, creams and lotions, sunscreens and the like.

Examples of home care applications include those useful for home care and industrial and institutional applications, such as laundry detergents; dishwashing detergents (automatic and manual); hard surface cleaners; hard surface cleaners and sanitizers; polishes (shoe, furniture, metal, etc.); automotive waxes, protectants and the like.

Examples of pharmaceutical applications include topical formulations in the form of creams, lotions, ointments, or gels, where the surfactant may be used as a wetting aid for the pharmaceutically active material, or as a skin penetration enhancer, or as an emulsifier for a solvent phase having an aesthetic effect, or present to enhance the solubility or bioavailability of the pharmaceutically active material. Similar formulations for internal application within the living body, or oral administration, or administration by mechanical means, can be utilized.

In addition to the previously mentioned essential and optional constituents of the light duty liquid detergent, one may also employ normal and conventional adjuvants, provided they do not adversely affect the properties of the detergent. Thus there may be used a cationic antibacterial agent, coloring agents and perfumes: polyethylene glycol, ultraviolet light absorbers such as the Uvinuls, which are products of GAF Corporation: pH modifiers; etc. The proportion of such adjuvant materials, in total will normally not exceed 15% by weight of the detergent composition, and the percentages of illustrative examples of such individual components will be about 5% by weight. Sodium formate or formalin or Quaternium 15 (Dowicil 75) can be included in the formula as a preservative at a concentration of about 0.1 to 4.0 wt. %.

The present light duty liquid detergents such as dishwashing liquids are readily made by simple mixing methods from readily available components which, on storage, do not adversely affect the entire composition. Solubilizing agents such as ethanol, hexylene glycol, sodium chloride and/or sodium xylene or sodium xylene sulfonate may be used to assist in solubilizing the surfactants. The viscosity of the light duty liquid composition desirably will be at least 100 centipoises (cps) at room temperature, but may be up to 1,000 centipoises as measured with a Brookfield Viscometer using a number 21 spindle rotating at 20 rpm. The viscosity of the light duty liquid composition may approximate those of commercially acceptable light duty liquid compositions now on the market. The viscosity of the light duty liquid composition and the light duty liquid composition itself remain stable on storage for lengthy periods of time, without color changes or settling out of any insoluble materials. The pH of the composition is about 3 to 8.0. The pH of the composition can be adjusted by the addition of Na₂O (caustic soda) to the composition.

All of the references cited herein and appended hereto, including patents, patent applications, literature publications, and the like, are hereby incorporated in their entireties by reference.

The following example illustrates liquid cleaning compositions of the described invention. Unless otherwise specified, all percentages are by weight. The exemplified compositions are illustrative only and do no limit the scope of the invention. It will be understood by those of skill in the art that numerous and various modifications can be made without departing from the spirit of the present invention. Therefore, it should be clearly understood that the forms of the present invention described herein are illustrative only and are not intended to limit the scope of the invention.

### Example 1

Example 1 illustrates illustrative light duty liquid cleaning composition formulations using ethoxylated materials made using a KOH ethoxylation catalyst. Test formula A contained a 50:50 blend of Safol® 0 and 3 mmol ethoxylated C₁₄-C₁₅ (i.e., Safol 45E3 and Safol 45) (branched Fischer-Tropsch) alcohol sulfates. Test formula B contained a 50:50 blend of Sasol® 0 and 3 mol ethoxylated C₁₂-C₁₃ or 23 (branched Fischer-Tropsch) alcohol sulfates. Test formula C contained a 50:50 blend of Safol® 0 and 3 mol ethoxylated C₁₄ (linear Ziegler) alcohol sulfates. Formula D was a control.

Example 1 illustrates illustrative embodiments containing a 50:50 blend of Safol® 0 and 3 mol ethoxylated C₁₄-C₁₅ or 45 (branched Fischer-Tropsch) alcohol sulfates unexpectedly gave better performance that the C₁₂-C₁₃ or 23 (branched Fischer-Tropsch) alcohol sulfates or the ethoxylated C₁₄ (linear Ziegler) alcohol sulfates in Test Formulas B and C as illustrated by the shake foam test.

Specifically, a 50:50 blend of Safol45 containing 0 and 3 mol ethoxylated C₁₄-C₁₅ (branched Fischer-Tropsch, for example Safol 45E3 or Safol 45, respectively) alcohol sulfates demonstrated increased loam volume over the C₁₂-C₁₃ (branched Fischer-Tropsch, for example Safol 23E3 or Safol 23) alcohol sulfates and the ethoxylated C₁₄ (linear Ziegler) alcohol sulfates.

| Ingredients | Test A | Test B | Test C | Test D-Control |
|---|---|---|---|---|
| Ammonium Alkyl Ether Sulfate, 1.3 | | | | 17.1 |
| degrees of ethoxylation | | | | |
| Alfol C₁₄E3 Sodium Ether Sulfate (KOH) | | | 8.5 | |
| Alfol C₁₄ Sodium Ether Sulfate | | | 8.5 | |
| Safol 45E3 Sodium Ether Sulfate | 8.5 | | | |
| (KOH) | | | | |
| Safol 45 Sodium Ether Sulfate | 8.5 | | | |
| Safol 23E3 Sodium Ether Sulfate | | 8.5 | | |
| (KOH) | | | | |
| Safol 23 Sodium Ether Sulfate | | 8.5 | | |
| Sodium Linear Alkyl Sulfonate | 8.3 | 8.3 | 8.3 | 8.3 |
| C₁₂-C₁₄ Amidopropylamine Oxide | 1.1 | 1.1 | 1.1 | 1.1 |
| SD3A Alcohol | 3.3 | 3.3 | | |
| Sodium Bisulfite | 0.02 | 0.02 | 0.02 | 0.02 |
| Color Solution | | | | |
| Fragrance Perfume | 0.3 | 0.3 | 0.3 | 0.3 |
| Preservative | | | | |
| Magnesium Sulfate | 0.5 | 0.5 | 0.5 | 0.5 |
| salt | 0.7 | 0.7 | 1.75 | 1.75 |
| Sodium Xylene Sulfonate | 0.6 | 0.6 | 0.6 | 0.6 |
| Pentasodium Pentatate | | | | |
| Sulfuric Acid | q.s. | q.s. | q.s. | q.s. |
| Deionized Water | balance | balance | balance | balance |
| Foam Measurements | | | | |
| Initial (mL) | 413 | 400 | 129 | 423 |
| With Soil (mL) | 178 | 144 | 124 | 179 |

The Compositions are reported in % Active Ingredients. Test formulas ethoxylated materials were made using KOH ethoxylation catalyst. The final pH was adjusted to between 6.5 and 7.5.

What is claimed is:

1. A cleaning composition comprising:
(i) at least one anionic sulfonate surfactant;
(ii) at least one amine oxide;
(iii) at least one C₁₄-C₁₅ alcohol sulfate; and
(iv) at least one C₁₄-C₁₅ alcohol ethoxylate ether sulfate.

2. The cleaning composition of claim 1, wherein the C₁₄-C₁₅ alcohol sulfate is present in an amount of about 2 wt. % to about 10 wt. %.

3. The cleaning composition of claim 1, wherein the C₁₄-C₁₅ alcohol ethoxylate ether sulfate is present in an amount of about 2 wt. % to about 10 wt. %.

4. The cleaning composition of claim 1, wherein the anionic sulfonate surfactant is a linear alkyl sulfonate.

5. The cleaning composition of claim 1, wherein the amine oxide is a C₁₂-C₁₄ amidopropylamine oxide.

6. The cleaning composition of claim 1, wherein the anionic sulfonate surfactant is present in an amount of about 0.1 wt. % to about 5 wt. % and the amine oxide is present in an amount of about 0.1 wt. % to about 5 wt. %.

7. A method of making a cleaning composition comprising combining the following:
(i) at least one anionic sulfonate surfactant;
(ii) at least one amine oxide;
(iii) at least one C₁₄-C₁₅ alcohol sulfate; and
(iv) at least one C₁₄-C₁₅ alcohol ethoxylate ether sulfate.

8. The method of claim 7, wherein the anionic sulfonate surfactant is present in an amount of about 0.1 wt. % to about 5 wt. %.

9. The cleaning, composition of claim 7, wherein the amine oxide is present in an amount of about 0.1 wt. % to about 5 wt. %.

10. The method of claim 7, wherein the C₁₄-C₁₅ alcohol sulfate is present in an amount of about 2 wt. % to about 10 wt.

11. The method of claim 7, wherein the C₁₄-C₁₅ alcohol ethoxylate ether sulfate is present in an amount of about 2 wt. % to about 10 wt. %.

12. The method of claim 7, wherein the anionic sulfonate surfactant is a linear alkyl sulfonate.

13. The method of claim 7, wherein the amine oxide is a C₁₂-C₁₄ amidopropylamine oxide.
